(19) United States
(12) Patent Application Publication
(10) Pub. No.: US 2018/0117751 A1
(43) Pub. Date: May 3, 2018

(54) PRYING TOOL DEVICE AND METHOD

(71) Applicant: Terry Caddell, Shell Knob, MO (US)

(72) Inventor: Terry Caddell, Shell Knob, MO (US)

(21) Appl. No.: 15/798,293

(22) Filed: Oct. 30, 2017

Related U.S. Application Data
(60) Provisional application No. 62/415,819, filed on Nov. 1, 2016.

(51) Int. Cl. B25C 11/00

(52) U.S. Cl. CPC B25C 11/00

(57) ABSTRACT

A prying tool; the prying tool having a length of flat, metal alloy bar stock having substantially uniform thickness forming an elongated body having a first end and a second end including a plurality of angled fastener engagement notches cut into its ends and sides so configured to provide a double ended leveraging fulcrum for removal of nail and staple fasteners that may be in difficult or hard to reach places. Useful for roofing, wood construction, and demolition.

### CROSS-REFERENCE TO RELATED APPLICATION(S)

The present application is related to and claims priority to U.S. Provisional Patent Application No. 62,415,819 filed Nov. 1, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### Technical Field

The present invention relates generally to the field of tools of existing art and more specifically relates to levers or prying type tools.

### Related Art

In roofing removal applications, such as shingle removal, it is quite common for the shingle underlayment to have been fastened to the roof material (typically wood) with staples which may require prying action to remove. Staple removal is a task that is becoming more common in many structural renovation and/or demolition projects, especially those in which the substrate material should remain intact, as staples replace nails and other types of fasteners as the fastener of choice in many tacking applications. Conventional means for prying may not be efficient in use. An efficient and effective tool is desired.

U.S. Pub. No. 2011/0155979 to Jason Sindt relates to a prying tool. The described prying tool is suitable for staple removal and includes an elongate shaft with prying member disposed at one or both ends, (each) having a flat section terminating in a serrated, distal edge, and forming an integral fulcrum between the shaft and the serrated edge. The distal edge consists of parallel, wedge-like teeth, separated by rounded notches, each tooth tapering along its length to a sharp point at the tip, which is rounded across its width. The taper may be achieved via a forward beveled surface on the top face of the tooth. The width of the tooth may also taper from the bottom to the top face, with the top edges rounded and/or beveled. The configuration allows a tooth to engage a staple, then gradually straighten and lift it by distributing upward force evenly thereto, reducing staple breakage, and the rounded notches prevent the staple legs from lodging in the tool.

### SUMMARY OF THE INVENTION

In view of the foregoing disadvantages inherent in the known implements or apparatus for applying pushing or pulling force art, the present disclosure provides a novel prying tool device and method. The general purpose of the present disclosure, which will be described subsequently in greater detail, is to provide an improved nail bar having multiple angled nail and staple removal slots cut into its ends and sides useful for roofing, wood construction and demolition, by providing a means for removing nails and staples that may be in difficult or hard to reach places.

A prying tool is disclosed herein. The prying tool includes a prying tool for removing nails and staples, the prying tool comprising: a length of flat, metal alloy bar stock which preferably has a substantially uniform thickness forming an elongated body which may have opposite (opposing) ends; a first end extending at an arcuate angle from the elongated body may have an inclined plane tapering to a thin edge; a second end extending from the elongated body may have a bidirectional right angle curvature may have an inclined plane tapering to a second edge; and the prying tool may have the first end and the second end which may include a plurality of fastener engagement notches. As such the prying tool is configured to provide a double ended leveraging fulcrum for removal of nail and the staple fasteners.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a prying tool device and method, constructed and operative according to the teachings of the present disclosure.

FIG. 1 is an in-use view of the prying tool according to an embodiment of the disclosure.

FIG. 2 is a side view of the prying tool of FIG. 1, according to an embodiment of the present disclosure.

FIG. 3 is a perspective view of the prying tool of FIG. 1, according to an embodiment of the present disclosure.

FIG. 4 is a perspective view of the prying tool of FIG. 1, according to an embodiment of the present disclosure.

FIG. 5 is a flow diagram illustrating a method of use for the prying tool, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to implements or apparatus for applying pushing or pulling force and more particularly to a prying tool device and method as used to improve the special engaging feature.

Generally speaking, many people use nails and staples during construction to hold objects in place. These nails/staples may need to be removed before finalizing the work. Typically, the nails/staples have a sharp point on one end and a flattened head on the other, which can be grabbed by a tool for removal. This prying tool gets up under wood shake shingles and pulls nails and staples without damaging underlying felt which is desirable. The apparatus also works well when used to remove composition shingles and the prying tool works efficiently for many other applications like wood framed construction and demolition. The device offers a means for removing angled nails and staples that may be in hard to access areas. It affords users access to areas under roofing shingles and pulls out nails and staples. The present invention includes multiple angled slots to accommodate nails and staples in various positions.

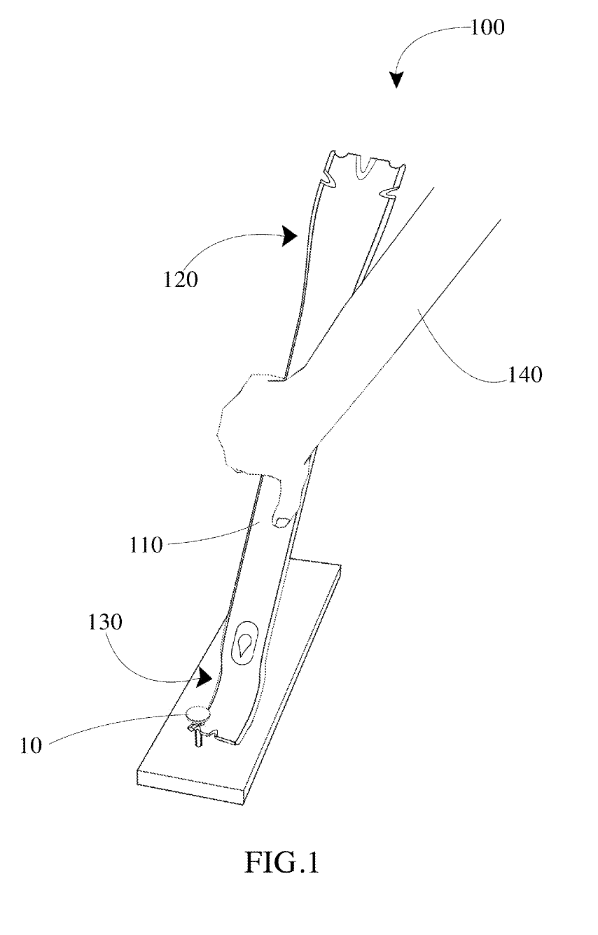

Referring now more specifically to the drawings by numerals of reference, there is shown in FIGS. 1-4, various views of a prying tool 100.

FIG. 1 shows a prying tool 100 during an ‘in-use’ condition 50, according to an embodiment of the present disclosure. Here, the prying tool 100 may be beneficial for use by a user 140 to provide a means for removing nails and staples that may be in difficult or ‘hard to reach’ places. As illustrated, the prying tool 100 may include a length of flat, metal alloy bar stock having a substantially uniform thickness forming an elongated body 110 having opposite ends. The first end 120 extending at an arcuate angle from the elongated body 110 having an inclined plane tapering to a thin edge. The second end 120 extends from the elongated body 110 having a bidirectional right angle curvature 132 having an inclined plane tapering to a second edge and the prying tool 100 having a first end 120 and a second end 130 includes a plurality of fastener engagement notches 114. The prying tool 100 may be configured to provide a double ended leveraging fulcrum for removal of nail and staple fasteners 10. Upon reading this specification, it should be appreciated that, under appropriate circumstances, considering such issues as user preferences, design preference, structural requirements, marketing preferences, cost, available materials, technological advances, etc., other or different fastener engagement arrangements such as, for example, angles, placement, chamfers, size etc., may be sufficient.

According to one embodiment, the prying tool 100 may be arranged as a kit 105. In particular, the prying tool 100 may further include a set of instructions 107. The instructions 107 may detail functional relationships in relation to the structure of the prying tool 100 such that the prying tool 100 can be used, maintained, or the like, in a preferred manner.

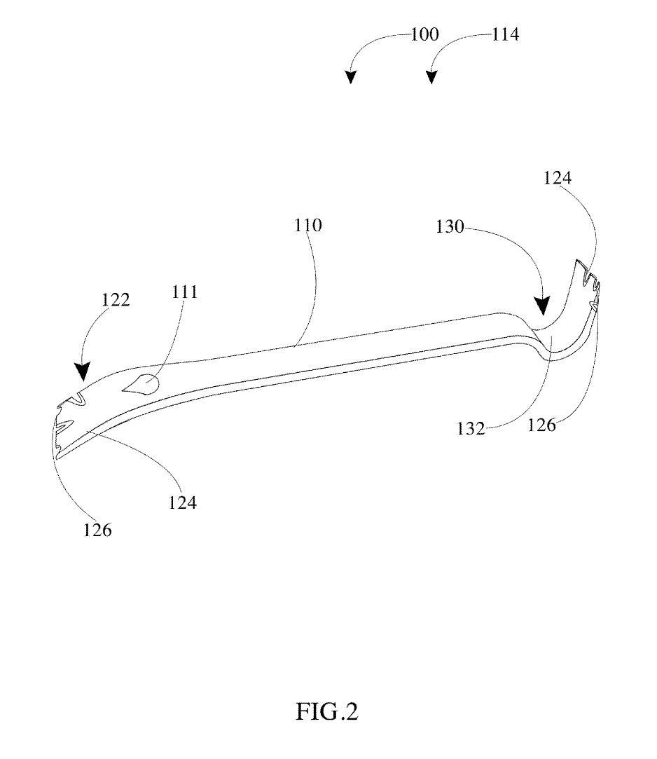

FIG. 2 is a side view of the prying tool 100 of FIG. 1, according to an embodiment of the present disclosure. As above, the prying tool 100 may include a length of flat, metal alloy bar stock that may comprise high carbon tempered steel having substantially uniform thickness forming an elongated body 110 having opposite ends. The elongated body 110 portion of the prying tool 100 may be configured to provide a handle to be used as a lever when at least one of the engagement notches 114 is engaged with a fastener 10. Embodiments of the present disclosure may be envisioned to include the same or similar configuration comprising other metal alloys or composite materials having sufficient thickness and strength to overcome the forces generated by the prying tool 100.

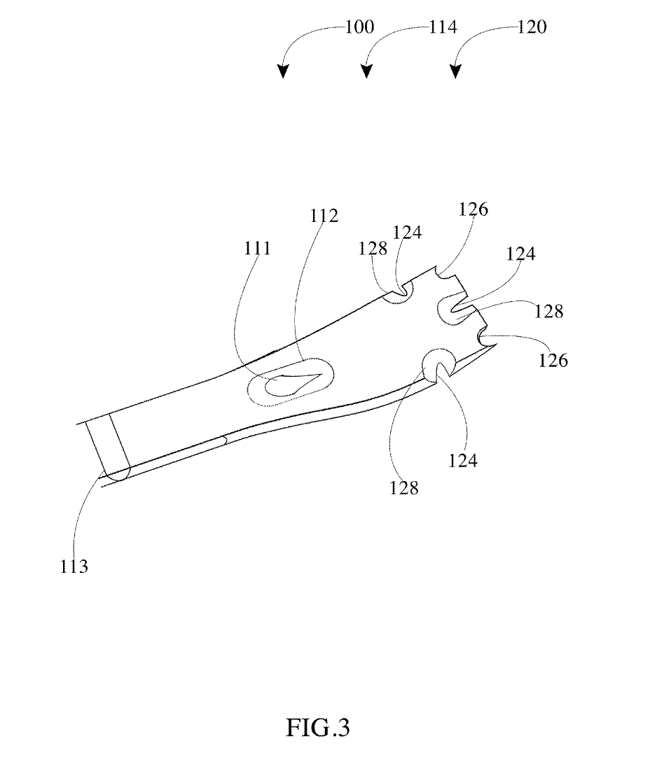

Additionally, according to an embodiment of present disclosure the elongated body 110 may further be configured to include elliptical cross section(s) 113 as shown in FIG. 3 to provide ergonomic comfort to a user 140; wherein the first end 120 is integral to the elongated body 110 and extends at an arcuate angle from the elongated body 110 having an inclined plane tapering to a thin edge. The first end 120 extends at an arcuate angle from the body 110 and may widen respectively to the inclined plane tapering to a thin edge as shown in FIG. 3. The second end 120 extending from the elongated body 110 preferably has a bidirectional right angle curvature 132 having an inclined plane tapering to a second edge which may also widen at a lateral portion of a bidirectional right angle curvature 132 respectively to the inclined plane tapering to a thin edge. The prying tool 100 has a first end 120 and a second end 130 including a plurality of fastener engagement notches 114 and as such may be structured and arranged to provide a double ended leveraging fulcrum for removal of nail and staple fasteners 10.

FIG. 3 is a perspective view of the prying tool 100 of FIG. 1, according to an embodiment of the present disclosure. The elongated body 110 includes an integral a first end 120. Additionally, the first end 120 may include a tear-drop-shaped 111 fastener engagement aperture proximal to the body 110 and the tear-drop-shaped 111 fastener engagement aperture may be surrounded by an elliptical depression 112. As shown here and also in FIG. 2, the first end 120 may be extending at an arcuate angle from the body 110 and may be configured to have a rectangular cross section 122 and may also widen respectively to the inclined plane tapering to a thin edge.

As illustrated the first end 120 may further include at least a first V-shaped 124 fastener engagement notch centrally located distal to the body 110. The first V-shaped 124 fastener engagement notch may be surrounded by a chamfer 128 and may also include a small U-shaped 126 fastener engagement notch at each side of the first V-shaped 124 fastener engagement notch.

In other embodiments the first end 120 may further include a second V-shaped 124 fastener engagement notch and a third V-shaped 124 fastener engagement notch located in a distal quadrant on each side of the first end 120 the second V-shaped 124 fastener engagement notch and a third V-shaped 124 fastener engagement notch may be angled at approximately forty five degrees. As above the first V-shaped 124 fastener engagement notch, second V-shaped 124 fastener engagement notch and the third V-shaped 124 fastener engagement notch may be surrounded by a chamfer 128.

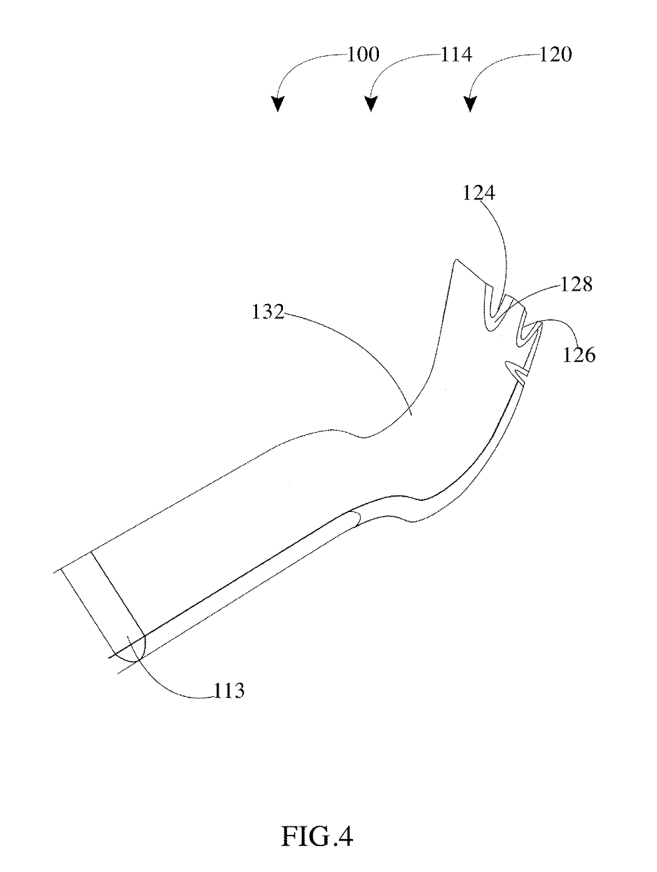

FIG. 4 is a perspective view of the prying tool 100 of FIG. 1, according to an embodiment of the present disclosure. The second end 130 also integral to the body 110, may include a bidirectional right angle curvature 132 having an inclined plane tapering to a second edge which may also widen at a lateral portion of a bidirectional right angle curvature 132 respectively to the inclined plane tapering to a thin edge and may preferably comprise a rectangular cross section. Additionally, the second end 130 may include a first V-shaped 124 fastener engagement notch surrounded by a chamfer 128 centrally located distal to the body and may further include a small U-shaped 126 fastener engagement notch on at least one side of the first V-shaped 124 fastener engagement notch.

Further referring to the second end 130 according to an embodiment of the present disclosure. The second end 130 may also include a second V-shaped fastener 124 engagement notch and a third V-shaped fastener 124 engagement notch located in the distal quadrant on each side of the second end 130 and may be angled at approximately forty five degrees. Additionally, the second V-shaped 124 fastener engagement notch and the third V-shaped 124 fastener engagement notch may be surrounded by a chamfer 128. Other angles may be used in alternate embodiments.

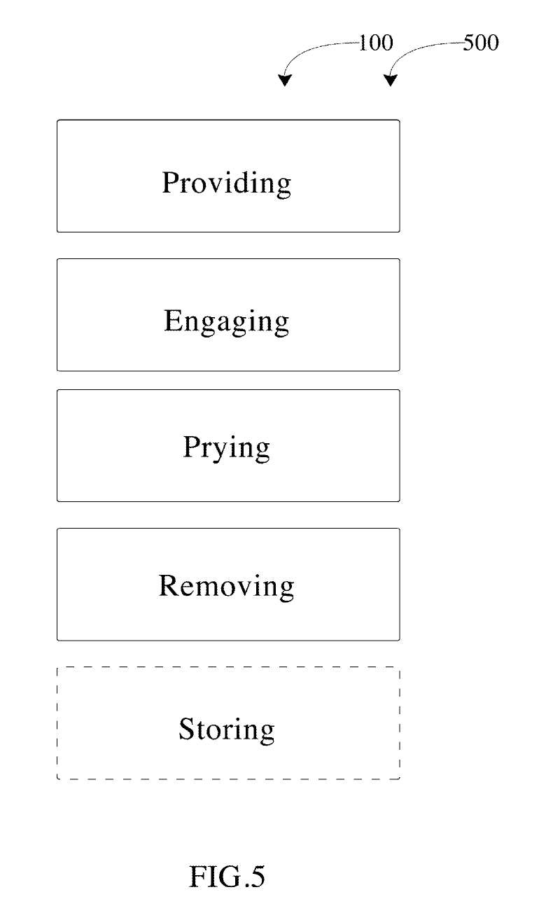

FIG. 5 is a flow diagram illustrating a method of use 500 for prying tool 100, according to an embodiment of the present disclosure. In particular, the method for using 500 prying tool 100 may include one or more components or features of the prying tool 100 as described above. As illustrated, the method for use 500 for the disclosed prying tool 100 may include the steps of: step one 501, providing a prying tool 100 for removing nails and staples, the prying tool 100 comprising: a length of flat, metal alloy bar stock having substantially uniform thickness forming an elongated body having opposite ends, a first end 120 extending at an arcuate angle from the body 110 having an inclined plane tapering to a thin edge, a second end 130 extending from the body 110 having a bidirectional right angle curvature 132 having an inclined plane tapering to a second edge and the first end 110 and the second end 130 including a plurality of fastener engagement notches 114, configured to provide a double ended leveraging fulcrum for the removal of nail and staple fasteners 10; step two 502, engaging the prying tool 100 with the a nail or staple; step three 503, prying the nail or staple loose; step four 504, removing the nail or staple and step five 505, storing the prying tool 100. Those with ordinary skill in the art will now appreciate that upon reading this specification and by their understanding the art of implements or apparatus for applying pushing or pulling force as described herein, methods of use will be understood by those knowledgeable in such art.

It should be noted that step 505 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for prying and use of the disclosed tool, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A prying tool for removing nails and staples, the prying tool comprising:
a length of flat, metal alloy bar stock having substantially uniform thickness forming an elongated having opposite ends;
a first end extending at an arcuate angle from said elongated body having an inclined plane tapering to a thin edge; and
a second end extending from said elongated body having a bidirectional right angle curvature having an inclined plane tapering to a second edge; and
said prying tool having said first end and said second end including a plurality of fastener engagement notches, said prying tool configured to provide a double ended leveraging fulcrum for removal of said nail and said staple fasteners.

2. The prying tool of claim 1, wherein the length of flat, metal alloy bar stock is high carbon tempered steel.

3. The prying tool of claim 1, wherein the first end includes a tear-drop-shaped fastener engagement aperture proximal to said body.

4. The prying tool of claim 3, wherein the tear-drop-shaped fastener engagement aperture is surrounded by an elliptical depression.

5. The prying tool of claim 1, wherein the first end extending at an arcuate angle from said body widens respectively to said inclined plane tapering to a thin edge.

6. The prying tool of claim 1, wherein the second end extending from said body widens at a lateral portion of a bidirectional right angle curvature respectively to said inclined plane tapering to a thin edge.

7. The prying tool of claim 1, wherein the elongated body includes an arcuate plane

8. The prying tool of claim 1, wherein the elongated body comprises an elliptical cross section.

9. The prying tool of claim 1, wherein the first end extending at an arcuate angle from said body comprises a rectangular cross section.

10. The prying tool of claim 6, wherein the lateral portion of said bidirectional right angle curvature comprises a rectangular cross section.

11. The prying tool of claim 1, wherein the first end and said second end include a first V-shaped fastener engagement notch centrally located distal to said body.

12. The prying tool of claim 11, wherein the first V-shaped fastener engagement notch is surrounded by a chamfer.

13. The prying tool of claim 12, wherein the first end and said second end include a small U-shaped fastener engagement notch at each side of said first V-shaped fastener engagement notch.

14. The prying tool of claim 12, wherein the first end includes a second V-shaped fastener engagement notch and a third V-shaped fastener engagement notch located in a distal quadrant on each side of said first end.

15. The prying tool of claim 14, wherein the a second V-shaped fastener engagement notch and a third V-shaped fastener engagement notch located in the distal quadrant on each side of said first end are angled at approximately forty five degrees.

16. The prying tool of claim 14, wherein the second V-shaped fastener engagement notch and said third V-shaped fastener engagement notch are surrounded by said chamfer.

17. A prying tool, the device comprising:
a length of flat, metal alloy bar stock having substantially uniform thickness forming an elongated body having opposite ends, a first end extending at an arcuate angle from said body having an inclined plane tapering to a thin edge, a second end extending from said body having a bidirectional right angle curvature having a second inclined plane tapering to a second edge and said first end and said second end including a plurality of fastener engagement notches, configured to provide a double ended leveraging fulcrum for the removal of nail and staple fasteners,
wherein the length of flat, metal alloy bar stock is high carbon tempered steel,
wherein the first end includes a tear-drop-shaped fastener engagement aperture proximal to said body,
wherein the tear-drop-shaped fastener engagement aperture is surrounded by an elliptical depression,
wherein the first end extending at an arcuate angle from said body widens respectively to said inclined plane tapering to a thin edge,
wherein the second end extending from said body widens at a lateral portion of said bidirectional right angle curvature respectively to said inclined plane tapering to a thin edge,
wherein the elongated body includes an arcuate plane,
wherein the elongated body comprises an elliptical cross section,
wherein the first end extending at an arcuate angle from said body comprises a rectangular cross section,
wherein the lateral portion of said bidirectional right angle curvature comprises a rectangular cross section,
wherein the first end and said second end include a first V-shaped fastener engagement notch centrally located distal to said body,
wherein the first V-shaped fastener engagement notch is surrounded by a chamfer,
wherein the first end and said second end include a small U-shaped fastener engagement notch at each side of said first V-shaped fastener engagement notch,
wherein the first end includes a second V-shaped fastener engagement notch and a third V-shaped fastener engagement notch located in the distal quadrant on each side of said first end,
wherein the second V-shaped fastener engagement notch and a third V-shaped fastener engagement notch located in the distal quadrant on each side of said first end are angled at approximately forty five degrees, and
wherein the second V-shaped fastener engagement notch and said third V-shaped fastener engagement notch are surrounded by said chamfer.

18. The prying tool of claim 17, further comprising set of instructions; and
wherein the prying tool is arranged as a kit.

19. A method of use for a prying tool, the method comprising the steps of:
providing a prying tool for removing nails and staples, the prying tool comprising: a length of flat, metal alloy bar stock having substantially uniform thickness forming an elongated body having opposite ends, a first end extending at an arcuate angle from said body having an inclined plane tapering to a thin edge, a second end extending from said body having a bidirectional right angle curvature having an inclined plane tapering to a second edge and said first end and said second end including a plurality of fastener engagement notches, configured to provide a double ended leveraging fulcrum for the removal of nail and staple fasteners,
engaging said prying tool with the nail or staple,
prying said nail or staple loose, and
removing said nail or staple.

20. The method of claim 19, further comprising the step of storing said prying tool.
